(19) United States
(12) Patent Application Publication
(10) Pub. No.: US 2005/0072321 A1
(43) Pub. Date: Apr. 7, 2005

(54) Method of making frozen products with a characteristic form from at least one flowable type of material, apparatus and use hereof

(76) Inventor: Peter H Larsen, (US)

Correspondence Address: CANTOR COLBURN, LLP, 55 GRIFFIN ROAD SOUTH, BLOOMFIELD, CT, 06002, US

(21) Appl. No.: 10/473,506

(22) PCT Filed: Mar. 27, 2002
(86) PCT No.: PCT/DK02/00218

(30) Foreign Application Priority Data
Mar. 28, 2001 (DK) PA 200100518

(51) Int. Cl. A23B 4/08

(52) U.S. Cl. 99/517

(57) ABSTRACT

The invention relates to a method of making frozen products with a characteristic form from at least one flowable type of material, the frozen products including edible ice products such as ice cream sticks, ice lollipops, ice dessert or the like. The method includes placing a first quantity of the flowable type of material in a first mould or moulding part and cooling the material of the at least one first mould or moulding part in order to create a basic frozen form of the product. Further, the method includes forming the frozen form of the product into a characteristic form, this forming including modification of the product in a second mould or moulding part, the second mould or moulding part basically having the contours of the characteristic form.

### BACKGROUND OF THE INVENTION

The present invention relates to a method of making frozen products with a characteristic form from at least one flowable type of material, an apparatus and use hereof.

In the area of creating frozen products, such as ice cream sticks or ice lollipops, it desirable to make frozen products with a characteristic form.

So far, the characteristic form has been achieved by using a freezing mould with the desired characteristics. However, this method has the disadvantage of making frozen products with a somewhat blurred form.

Further, the method does not allow quality surfaces with details to be made, as the method is too crude. With the method, it is also very difficult to mass fabricate the frozen products with a high degree of uniformity.

If the frozen product is applied with a surface of another material, such as chocolate, it is especially difficult to achieve uniform and detailed products with the known method. The material will usually hide or smooth out any details under the surface.

The invention provides a method and apparatus for making frozen products with a characteristic form from at least one flowable type of material without the above-mentioned disadvantages.

Especially, the invention provides a method and apparatus for making frozen products with a characteristic form in which high-quality characteristics and details are produced, e.g. well-defined and distinct, regardless of whether they are simple or complicated in shape and have surfaces of another material.

### SUMMARY OF THE INVENTION

In accordance with the invention a method of making frozen products with a characteristic form from at least one flowable type of material is stated, said frozen products comprising edible ice products such as ice cream sticks, ice lollipops, ice dessert or the like, said method including the following steps: placing a first quantity of said flowable type of material in a first mould or moulding part in order to create a basic frozen form of an ice product, adding a surface coating to said basic frozen form, and forming said frozen form of the product into a characteristic form, said forming including modification of the product in a second mould or moulding part, said second mould or moulding part basically comprising the contours of said characteristic form.

Hereby, it is possible to create a frozen product with a surface coating and a characteristic form, such as a 3D figure, that is well-defined and distinct in its details.

The phrase “flowable type of material” may be understood as any type of edible fluid such as ice cream mix, fruit juice, lemonade or soft drink that may be frozen.

The term “modification” is to be understood as a change of the basic form of the product, said basic form already comprising a form close to the finalized product.

The modification may provide a more accurate defining or shaping of already existing details which have bee blurred by e.g. a surface coating.

The phrase “mould or moulding part” is to be understood to include more than one moulding apparatus, each dedicated to a step in the production process or to include one moulding apparatus performing one or more formings of a frozen product during the production process.

Further, the term “mould” is to be understood as any kind of process for creating a product in a form or forming part. The form may be a standard mould with one or more sections defining an interior chamber to be filled with the flowable product. In a more viscous version, the flowable product may be extruded before imposing an open mould on the product. Other possible types of forming methods and moulds are known by the skilled person.

Further examples of ice products may be ice bars, slices, logs, cakes, tubs or the like.

In an aspect of the invention, said basic frozen form partly or substantially comprises the characteristics of the frozen product after modification.

In another aspect of the invention, a surface of a liquid type of material is added to said basic frozen form of the product and solidified prior to modification. With a solidified surface, it is possible to obtain a surface with the desired characteristics regardless of the liquid type of material used. Especially, embossing details into the surface may restore details in the basic form which would usually be hidden by thicker liquid types.

In a further aspect of the invention, said modification includes cooling of the ice product in said first and/or second mould or moulding part(s), preferably by cooling the surface of said first and/or second mould or moulding part(s).

In an even further aspect of the invention, cooling is generated by means of a cryogenic material such as liquid nitrogen or dry ice. By using a cryogenic fluid, it is possible to obtain the low temperatures necessary or at least to make it easy to remove an ice product from a mould.

In another aspect of the invention, the temperature of said cooling is lower than minus 65 degrees Celsius, such as between minus 75 and 179 degrees Celsius, and preferably between minus 75 and 80 degrees Celsius. Hereby, a preferred relation between temperatures, cooling means, such as means based on a cryogenic fluid, and the ice products has been obtained. At the above-mentioned temperature intervals, it is especially easy to remove an ice product from a mould, as the surface gains an anti-stick-like characteristic in relation to the ice product.

During production, the ice product itself usually has a temperature of minus 5 to minus 20 degrees Celsius. As it contains a lot of air and water, the ice product is frozen but still of a rather soft nature which allows it to be processed e.g. embossed or stamped.

In a further aspect of the invention, the temperature of said cooling is controllable. Hereby, it is possible to create the optimal conditions during production for different types of ice products and surfaces as well as different types of modification. In particular, the temperature may be controlled just before or during modification when the surface of the ice product is chanced with the moulds.

In an even further aspect of the invention, the first mould or moulding part is also used as the second mould or moulding part.

Hereby, it is possible to create a compact and efficient system producing ice products with a surface coating comprising well-defined details.

Further, in accordance with the invention an apparatus for making frozen products with a characteristic form from at least one flowable type of material is stated, said frozen products comprising edible ice products such as ice cream sticks, ice lollipops, ice dessert or the like, said apparatus comprising at least one first mould or moulding part adapted for a first quantity of a flowable type of material, cooling means for cooling the material of said at least one first mould or moulding part in order to create a basic frozen form of the product, and forming means to form said basic frozen form of the product into a characteristic form, said forming means including a second mould or moulding part which substantially comprises the contours of said characteristic form.

Hereby, it is possible to create a frozen product, such as a 3D figure, with a characteristic form which is well-defined and distinct in its details.

### BRIEF DESCRIPTION OF THE DRAWINGS

The invention will be described in the following with reference to the figures, in which

FIG. 1 shows a preferred embodiment according to the invention schematically,

FIGS. 2a to 2f show the method steps of a preferred embodiment according to the invention,

FIGS. 3a & 3b show a first and second mould sections according to the invention, and

FIGS. 4a & 4b show an example of the basic form and finalized frozen product of the invention in perspective.

### DETAILED DESCRIPTION OF THE INVENTION

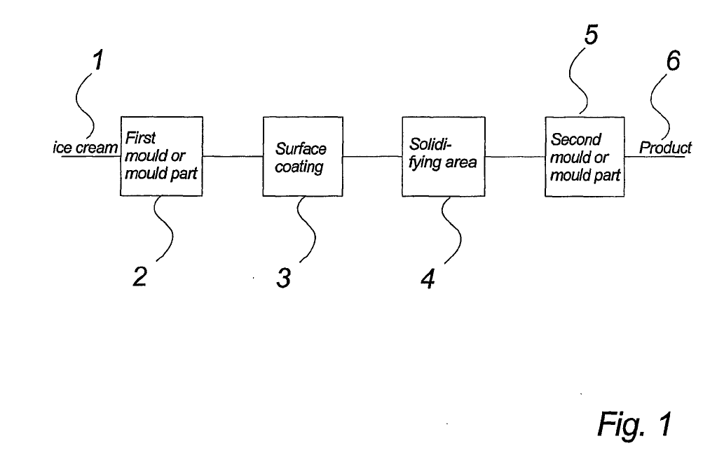

FIG. 1 shows a preferred embodiment of the invention schematically.

The embodiment comprises a method of making frozen ice products 6 with a characteristic form from an ice cream mix 1.

The first step of the method involves placing a first quantity of ice cream mix in a first mould 2. In the mould, the ice cream product obtains its basic form.

The second step involves adding of a surface to the basic frozen form of the ice product 3 after the first mould.

In the next step, the surface is solidified 4 by moving the ice product through a cooling area.

And in the last step, the basic frozen form is modified in a second mould which basically comprises the contours of the characteristic form 5.

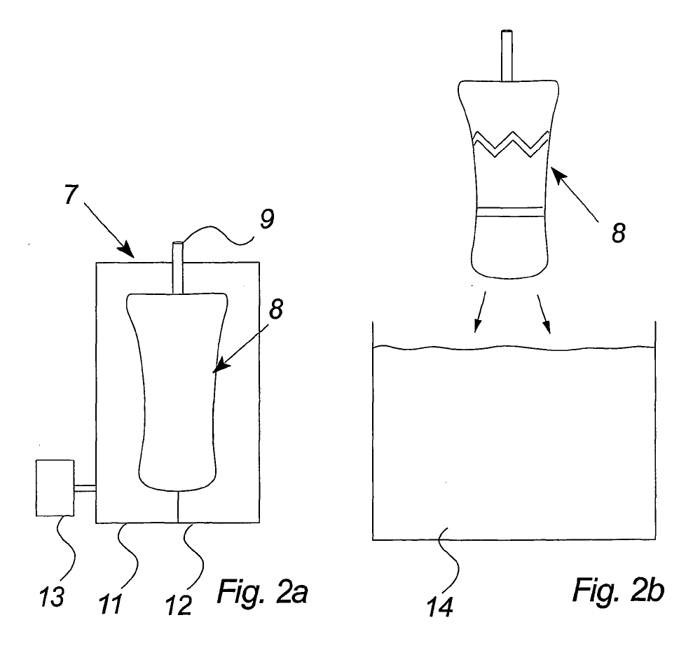

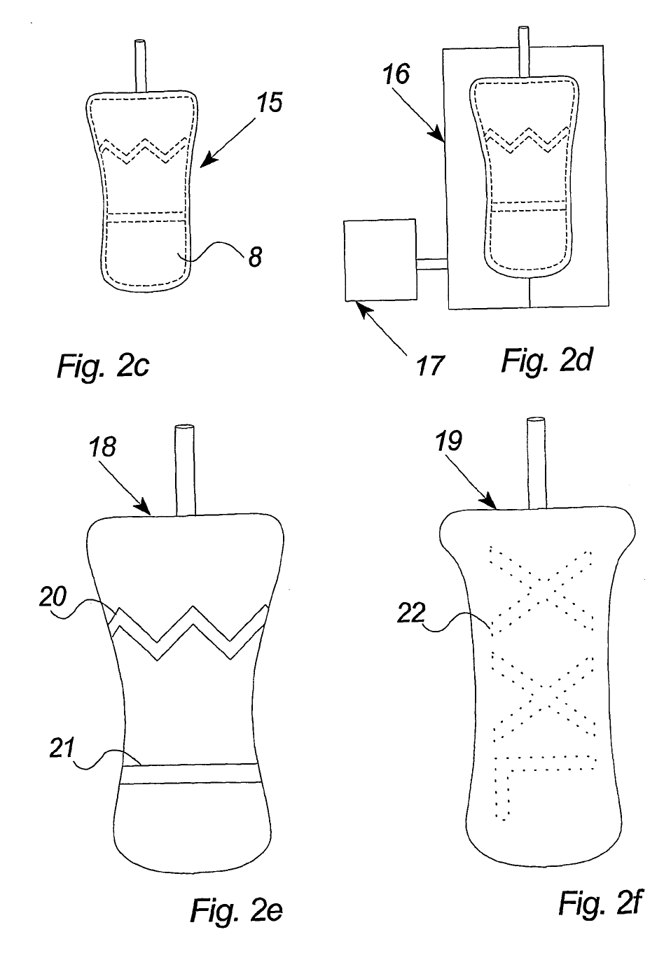

FIGS. 2a to 2f show in detail a preferred method of creation of a frozen ice product with a characteristic form. The ice product created by the method is illustrated with ice cream or lollipop sticks and may be part of a standard ice production system in which the ice cream or lollipop sticks are conveyed in well-known product lines to the moulds etc. and subsequently packed in the necessary packaging by well-known packaging machines.

FIG. 2a shows the first mould 7 which comprises two mould sections 11, 12 defining an inner volume corresponding to the basic form 8 of the ice product. The ice product is illustrated by a holding stick 9 placed in the mould and the ice cream.

The mould is connected with cooling means 13 which supplies cooling in order to freeze the ice product. The cooling may be in the form of a cryogenic fluid, such as liquid nitrogen or dry ice, flowing in close proximity to the inner surfaces of the mould sections.

After the freezing, the mould sections may be separated and the frozen basic form 8 of the ice product be conveyed to the next phase of the production.

FIG. 2b shows the basic frozen form 8 of the ice product with a well-defined surface pattern 10. The ice product is conveyed to a container 14 containing a liquid such as chocolate or fruit juice. As indicated on the figure, the ice product is immersed in the liquid and thus provided with a surface layer of the liquid.

FIG. 2c shows the basic form of the ice product 8 with a solidified surface of the liquid 15. In order to solidify the layer quickly, the ice product is cooled down to a low temperature, e.g. by using a hardening tunnel for hardening of the ice cream and chocolate or fruit juice.

The pattern 10 of the basic frozen form 8 is indicated in the figure by dotted lines in order to illustrate the fact that the surface coating 15 covers and to some extent hides or blurs the pattern.

FIG. 2d shows the basic form of the ice product 8 with a solidified surface of the liquid 15 positioned in a second mould 16. The second mould defines an inner volume which substantially corresponds in size to that of the basic form of the ice product 8 with a solidified surface of the liquid. The inner surface of the second mould may comprise any kind of relief or contour to modify the surface in order to create a frozen product with a characteristic three-dimensional form or figure. The relief or contour may take on different shapes, marks, stamps, patterns, projections etc.

The second mould is connected to cooling means 17 in order to keep the ice product frozen during modification and to ensure that the ice product may be removed from the mould without sticking to the surface.

FIGS. 2e and 2f show different finalized ice products 18, 19 with characteristic forms such as 3D figures. The products may include different shapes, patterns 20, 21 or commercial messages 22 such as brands, logos, trademarks etc. formed or embossed in the surface of the ice products.

In connection with FIGS. 2a to 2d, especially FIG. 2e illustrates a preferred embodiment of the invention in which a basic frozen product comprises a 3D figure shape. The 3D figure shape is to some extent hidden or blurred by a surface coating and in order to redefine the 3D figure shape of the product, is positioned in a second mould. The second mould comprises the 3D figure shape including the extra surface thickness, and the result or finalized ice product of FIG. 2e (and FIG. 2f) will appear with a surface having well-defined details such as patterns 20 to 22.

To maintain a smooth and even surface coating, the difference in size between the first and second mould is usually quite small e.g. a few millimetres or less.

In a special embodiment of the invention, the first and second moulds are one and the same mould performing both process steps when creating an ice product with a well-defined surface.

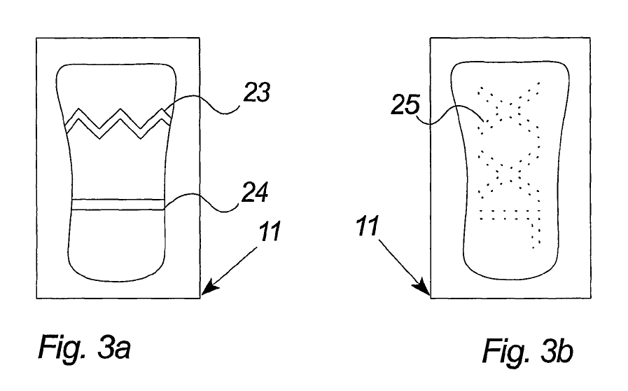

FIGS. 3a and 3b show two second mould sections 11 with inner surfaces having different patterns 23 to 25. The patterns are embossed into the frozen product positioned in the mould.

The inner surface of the mould may be coated with a Teflon® or a similar anti-stick surface.

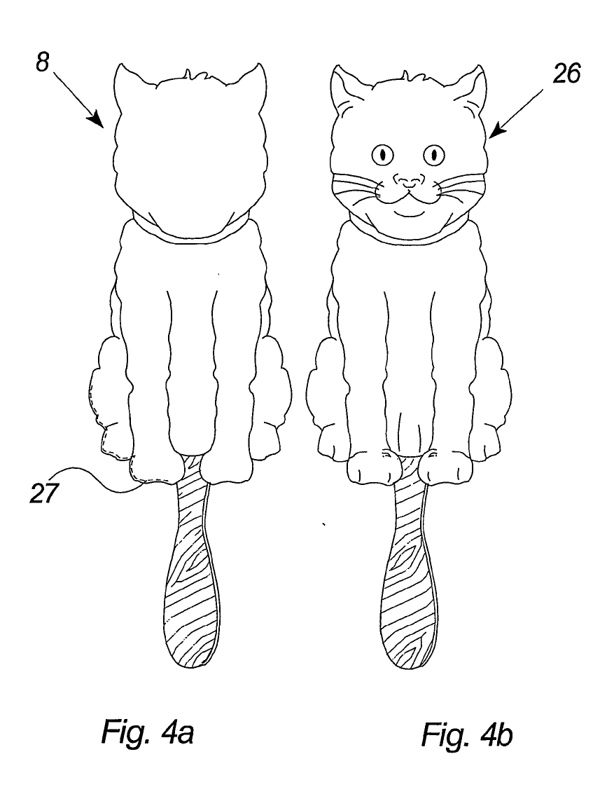

FIGS. 4a and 4b show an example of the basic frozen ice product 8 as a three-dimensional figure under the surface layer (in which a section of the basic frozen ice product is illustrated by a dotted line 27) and a corresponding finalized ice product 26.

The finalized product 26 comprises a number of details which are added to the basic frozen ice product in a second mould.

However, as indicated in the FIGS. 2e-f, 3a-3b, 4a and 4b, the basic frozen ice product 8 includes most of the features of the finalized ice product.

It should be emphasized that the above-mentioned embodiment may be subject to several variations within the scope of the invention.

The second mould may comprise more than one moulding part in which the different moulds modify different parts of the product.

Further, the first and second moulds may be integrated in one machine in order to minimize the necessary space occupied. Generally, it should be emphasized that the physical distance between the different moulds should be kept small. By keeping a small distance, the need for cooling is minimized and the product is kept frozen at all times during production.

In a variation, different types of large quantities of ice cream may replace the ice cream or lollipop sticks, such as ice desserts and ice cream tubs, and receive embossing or the like to the surface. Stamps or impresses may be pressed against only a part of the surface of the ice product instead of using a mould to create the characteristic form.

Further, a rolling stamp may generally be used to decorate ice products by rolling it over part of the surface of the products.

1. Method of making frozen products with a characteristic form from at least one flowable type of material, said frozen products comprising edible ice products such as ice cream sticks, ice lollipops, ice dessert or the like, said method comprising:
placing a first quantity of said flowable type of material in a first mould or moulding part in order to create a basic frozen form of the ice product,
adding a surface coating to said basic frozen form, and
forming said frozen form of the product into a characteristic form,
said forming including modification of the product in a second mould or moulding part, said second mould or moulding part comprising contours of said characteristic form.

2. Method according to claim 1, where in said basic frozen form partly or substantially comprises the characteristics of the frozen product after said modification.

3. Method according to claim 1, wherein said surface is a liquid type of material added to said basic frozen form of the product and solidified before said modification.

4. Method according to, claim 1, wherein said modification includes cooling of the ice product in said first and/or second mould or moulding part(s) by cooling the surface of said first and/or second mould or moulding part(s).

5. Method according to, claim 4, wherein cooling is generated by means of a cryogenic fluid such as liquid nitrogen or dry ice.

6. Method according to, claim 4, wherein a temperature of said cooling is lower than minus 65 degrees Celsius.

7. Method according to, claim 4, wherein a temperature of said cooling is controllable.

8. Method according to claim, 1, wherein the first mould or moulding part is also used as the second mould or moulding part.

9. An apparatus for making frozen products with a characteristic form from at least one flowable type of material, said frozen products comprising edible ice products such as ice cream sticks, ice lollipops, ice dessert or the like, said apparatus comprising
at least one first mould or moulding part adapted for a first quantity of the flowable type of material in order to create a basic frozen form of the product,
at least one surface coating area to provide said basic frozen form of the product with a surface coating, and
forming means to form said basic frozen form of the product with the surface coating into a characteristic form,
said forming means including a second mould or moulding part which comprises contours of said characteristic form.

10. Apparatus according to claim 9, wherein said basic frozen form partly or substantially comprises the characteristics of the frozen product after forming.

11. Apparatus according to claim, wherein at least one of said moulds or moulding sections is coated with a Teflon® or a similar anti-stick surface.

12. Apparatus according to claims, wherein at least one of said moulds or mould sections comprises cooling means cooled by means of a cryogenic fluid comprising liquid nitrogen or dry ice.

13. Apparatus according to claims 9, wherein said forming means includes means for adding a surface of a liquid type of material to said basic frozen form of the product and means for solidifying said surface.

14. Apparatus according to claims 13, wherein said liquid type of material is chocolate, fruit juice or the like.

15. Apparatus according to, wherein said moulds or moulding parts comprise two halves with inner forming surfaces.

16. Apparatus according to claims 9, wherein said contours comprise different shapes, marks, stamps, patterns, and/or projections in order to create the frozen product with a three-dimensional characteristic form.

17. Apparatus according to claims 13, wherein an interior of said second mould or moulding part is partly or substantially similar in size to that of the basic form and the added surface.

18. Apparatus according to claims 9, wherein an interior of said second mould or moulding part is partly or substantially similar in size to that of the first mould or moulding part.

19. Apparatus according to claims 9, wherein said first mould or moulding part and said second mould or moulding part is one and the same mould or moulding part.

20. The method of claim 1, wherein said method is utilized in connection with forming a surface coating of ice products such as cream sticks, lollipops, dessert, bars, slices, logs, cakes, tubs or the like into characteristic three-dimensional forms or figures.

21. The method of claim 1, wherein said method is utilized in connection with characteristics including commercial messages such as brands, logos, trademarks etc. formed or embossed in the surface of said products.

22. The apparatus of claim 9, wherein said apparatus is utilized to form a surface coating of ice products such as cream sticks, lollipops, desserts, bars, slices, logs, cakes, tubs or the like into characteristic three-dimensional forms or figures

23. Method according to claim 6, wherein the temperature of said cooling between minus 75 and 179 degrees Celsius.

24. Method according to claim 23, wherein said cooling is between minus 75 and 80 degrees Celsius.
